(19) United States
(12) Patent Application Publication
(10) Pub. No.: US 2021/0124138 A1
(43) Pub. Date: Apr. 29, 2021

(54) LIGHT SOURCE DEVICE

(71) Applicant: Fujikura Ltd., Tokyo (JP)

(72) Inventors: Yoshihiro Tabata, Sakura-shi (JP); Manabu Kudoh, Sakura-shi (JP); Katsuyuki Seto, Sakura-shi (JP); Kazuya Hiramatsu, Sakura-shi (JP)

(73) Assignee: Fujikura Ltd., Tokyo (JP)

(21) Appl. No.: 16/493,943

(22) PCT Filed: Apr. 3, 2018
(86) PCT No.: PCT/JP2018/014237

§ 371 Date: Sep. 13, 2019

(30) Foreign Application Priority Data
Apr. 3, 2017 (JP) 2017-073954

(51) Int. Cl. G02B 6/42; G02B 6/04; G02B 6/036

(52) U.S. Cl. CPC G02B 6/4296; G02B 6/036; G02B 6/04

(57) ABSTRACT

A light source device includes: a light source that outputs laser light; an optical fiber that includes: a proximal end on which the laser light is incident and a distal end portion including a distal end and a distal end surface at the distal end; a fixing member that fixes the optical fiber by surrounding an entire circumference of the distal end portion; and an optical component disposed at a position through which an extension line of the optical fiber at the distal end of the optical fiber passes.

### CROSS-REFERENCE TO RELATED APPLICATIONS

This is a U.S. National Stage application of International Application No. PCT/JP2018/014237 filed Apr. 3, 2018, which claims priority to Japanese Patent Application No. 2017-073954 filed Apr. 3, 2017. These references are incorporated herein by reference in their entirety.

### TECHNICAL FIELD

The present invention relates to a light source device.

### BACKGROUND

FIG. 37 is an end view of a launch end of a first example of a light guide for laser light. A light guide 100 includes a plurality of optical fibers 101, an adhesive 102 for fixing the optical fibers 101, and a protective member 104. The adhesive 102 is made of an epoxy resin or the like.

FIG. 38 is a cross-sectional view of a second example of the light guide for laser light. A light guide 110 has a structure in which a plurality of optical fibers 111 are melted and integrated in a glass tube 112.

FIG. 39 is a cross-sectional view of a third example of the light guide for laser light. The light guide 120 includes a plurality of optical fibers 121 and rod members 122 thinner than the optical fibers 121 (see, for example, Patent Document 1). In the light guide 120, the rod member 122 can limit non-circular deformation of the optical fiber 121, the non-circular deformation which the optical fiber 121 becomes non-circular shape.

### PATENT LITERATURE

[Patent Document 1] Japanese Unexamined Patent Application, First Publication No. 2011- 34040

In the light guide 100 shown in FIG. 37, in a case where the output of laser light is high, when an optical component such as a phosphor is installed at a position near the launch end, burnout may occur at the distal end of the light guide 100 by light reflected from the optical component.

In the light guide 110 shown in FIG. 38, the optical fiber 111 may be deformed by melting, and the beam profile may be non-circular (for example, elliptical).

In the light guide 120 shown in FIG. 39, the deformation of the optical fiber 111 can be reduced by the rod member 122, but the deformation of the circular shape of the optical fiber 111 cannot be completely prevented. Therefore, as in the light guide 110 of FIG. 38, the beam profile may be non-circular.

### SUMMARY

One or more embodiments of the present invention provide a light source device and an optical fiber unit for a light source device in which the distal end of the optical fiber is unlikely to be burnt out even when the output of the incident light is high, and disturbance of the beam profile is unlikely to occur.

A light source device according to one or more embodiments of the present invention includes a light source that is configured to output laser light; an optical fiber that has a proximal end, a distal end portion having a distal end, and a distal end surface at the distal end, the optical fiber that the laser light is incident from the proximal end; a fixing member that fixes the optical fiber by surrounding an entire circumference of at least the distal end portion of the optical fiber; and an optical component that is installed at a position through which an extension line of the optical fiber at the distal end of the optical fiber passes.

The fixing member may be in contact with the entire circumference of the optical fiber in at least the distal end portion of the optical fiber so as to surround the optical fiber.

The fixing member may be fused to the distal end portion of the optical fiber.

The fixing member may be fused to the entire circumference of the distal end portion of the optical fiber.

A difference between a core diameter of the optical fiber at the proximal end of the fixing member and a core diameter of the optical fiber at the distal end of the fixing member may be 10% or less of the core diameter of the optical fiber at the proximal end of the fixing member.

The optical component may be fixed so as to abut at least the distal end surface of the optical fiber.

At least the distal end surface of the optical fiber may have a light scattering structure, the optical component may be a phosphor formed of a fluorescent material, and the phosphor may be fixed so as to abut at least the distal end surface of the optical fiber.

The optical component may include a phosphor formed of a fluorescent material, and a relay fiber having a relay core and a relay cladding surrounding the relay core, the relay fiber having a first end surface and a second end surface, the first end surface of the relay fiber may be fixed so as to abut at least the distal end surface of the optical fiber, and the phosphor may be fixed to the second end surface of the relay fiber.

The second end surface of the relay fiber may have a light scattering structure.

A plurality of light sources including the light source; and a plurality of optical fibers including the optical fiber may be provided.

At least distal end surfaces of the plurality of optical fibers may have a light scattering structure, the optical component may be a phosphor formed of a fluorescent material, and the phosphor may be fixed so as to abut at least the distal end surfaces of the plurality of optical fibers.

The optical component may include a phosphor formed of a fluorescent material, and a relay fiber having a relay core and a relay cladding surrounding the relay core, the relay fiber having a first end surface and a second end surface, the first end surface of the relay fiber may be fixed so as to abut at least the distal end surfaces of the plurality of optical fibers, the phosphor may be fixed to the second end surface of the relay fiber, and an outer shape of the relay core may be set such that the distal end surfaces of all of the plurality of optical fibers held by the fixing member are collectively disposed inside the relay core, as viewed from a longitudinal direction of the relay fiber.

The second end surface of the relay fiber may have a light scattering structure.

The plurality of light sources may include a light source of red light, a light source of green light, and a light source of blue light.

The plurality of light sources may include the light source of red light, the light source of green light, and the light source of blue light, and at least the distal ends of the plurality of optical fibers may have a light scattering structure.

The optical component may include a relay fiber having a relay core and a relay cladding surrounding the relay core, the relay fiber have a first end surface and a second end surface, the first end surface of the relay fiber may be fixed so as to abut at least the distal end surfaces of the plurality of optical fibers, and an outer shape of the relay core may be set such that the distal end surfaces of all of the plurality of optical fibers held by the fixing member are collectively disposed inside the relay core, as viewed from a longitudinal direction of the relay fiber.

The second end surface of the relay fiber may have a light scattering structure.

Distal end portions of the plurality of optical fibers may be separated from each other by the fixing member.

The fixing member may be inserted into a holding member, and at least the distal end portion of the optical fiber may be fixed to the holding member with an inorganic adhesive or a silicone adhesive.

In at least distal end portions of the plurality of optical fibers which includes distal ends of the plurality of optical fibers, the fixing member may be fixed in contact with the entire circumference of each of the plurality of optical fibers so as to surround the plurality of optical fibers.

The fixing member may be fused to the distal end portions of the plurality of optical fibers.

The fixing member may be fused to the entire circumference of the distal end portions of the plurality of optical fibers.

According to one or more embodiments, the fixing member is fixed to surround the entire circumference of the distal end portion of the optical fiber. Since the fixing member surrounds the distal end portion, even if the output of the laser light is high, the distal end of the optical fiber unit is unlikely to be burnt out by heat or light. Therefore, the optical component can be disposed at a position close to the distal end of the optical fiber unit.

In addition, since the distal end portion of the optical fiber is surrounded by the fixing member, deformation of the distal end portion hardly occurs at the time of manufacture, and the non-circularity of the cross section of the distal end portion can be reduced. Therefore, disturbance of the beam profile is unlikely to occur.

Therefore, it is possible to provide a light source device in which the distal end of the optical fiber is unlikely to be burnt out even when the output of the incident light is high, and disturbance of the beam profile is unlikely to occur.

### BRIEF DESCRIPTION OF THE DRAWINGS

FIG. 1 is a schematic view of a light source device according to one or more embodiments of the present invention.

FIG. 2 is a cross-sectional view of a proximal end portion of an optical fiber unit of the light source device of FIG. 1.

FIG. 3 is a perspective view of a first fixing member of the optical fiber unit of the light source device of FIG. 1.

FIG. 4 is a cross-sectional view of a distal end portion of the optical fiber unit of the light source device of FIG. 1.

FIG. 5 is a perspective view of a second fixing member of the optical fiber unit of the light source device of FIG. 1.

FIG. 6 is a schematic view of a first example of a structure in which the optical component is fixed in contact with the distal end of the optical fiber.

FIG. 7 is a schematic view of a second example of the structure in which the optical component is fixed in contact with the distal end of the optical fiber.

FIG. 8A is a schematic view of a light source device according to one or more embodiments of the present invention.

FIG. 8B is a schematic view of a part of the light source device of FIG. 8A.

FIG. 9 is a cross-sectional view of a distal end portion of an optical fiber unit of the light source device of FIG. 8A.

FIG. 10 is a perspective view of a second fixing member of the optical fiber unit of the light source device of FIG. 8A.

FIG. 11 is a schematic view of a part of a modification example of the light source device according to one or more embodiments.

FIG. 12 is a schematic view of a part of a light source device according to one or more embodiments of the present invention.

FIG. 13 is a schematic view of a light source device according to one or more embodiments of the present invention.

FIG. 14 is a schematic view of an example of the light source device of FIG. 13 in which the optical component is installed at a position to abut the distal end of the optical fiber.

FIG. 15 is a schematic view of a light source device according to one or more embodiments of the present invention.

FIG. 16 is a schematic view of an example of a light source of the light source device of FIG. 15.

FIG. 17 is a schematic view of another example of the light source of the light source device of FIG. 15.

FIG. 18 is a schematic view of a light source device according to one or more embodiments of the present invention.

FIG. 19 is a cross-sectional view showing a part of the light source device of FIG. 18.

FIG. 20 is a schematic view of a first configuration example of a light source device according to one or more embodiments of the present invention.

FIG. 21 is a schematic view of a structure of a distal end portion of an optical fiber unit of the light source device of FIG. 20.

FIG. 22 is a schematic view of a structure of a distal end portion of an optical fiber unit of a second configuration example of the light source device according to one or more embodiments.

FIG. 23 is a schematic view of a first configuration example of a light source device according to one or more embodiments of the present invention.

FIG. 24 is a schematic view of a structure of a distal end portion of an optical fiber unit of the light source device of FIG. 23.

FIG. 25 is a schematic view of a structure of a distal end portion of an optical fiber unit of a second configuration example of the light source device according to one or more embodiments.

FIG. 26 is a schematic view of a first configuration example of a light source device according to one or more embodiments of the present invention.

FIG. 27 is a schematic view of a structure of a distal end portion of an optical fiber unit of the light source device of FIG. 26.

FIG. 28 is a schematic view of a second configuration example of the light source device according to one or more embodiments.

FIG. 29 is a schematic view of a structure of a distal end portion of an optical fiber unit of the light source device of FIG. 28.

FIG. 30 is a schematic view of a structure of a distal end portion of an optical fiber unit of a third configuration example of the light source device according to one or more embodiments.

FIG. 31 is a schematic view of another configuration example of the light source device according to one or more embodiments.

FIG. 32 is a schematic view of a first modification example of the optical fiber unit of the light source device according to one or more embodiments.

FIG. 33 is a schematic view of a second modification example of the optical fiber unit of the light source device according to one or more embodiments.

FIG. 34 is a schematic view of a third modification example of the optical fiber unit of the light source device according to one or more embodiments.

FIG. 35 is a schematic view of a fourth modification example of the optical fiber unit of the light source device according to one or more embodiments.

FIG. 36 is a schematic view of a fifth modification example of the optical fiber unit of the light source device according to one or more embodiments.

FIG. 37 is a schematic view of an end surface of a first example of a light guide for laser light.

FIG. 38 is a schematic view of an end surface of a second example of the light guide for laser light.

FIG. 39 is a schematic view of an end surface of a third example of the light guide for laser light.

### DETAILED DESCRIPTION

A light source device according to one or more embodiments of the present invention includes a light source that is configured to output laser light; an optical fiber that has a proximal end, a distal end portion having a distal end, and a distal end surface at the distal end, the laser light being incident from the proximal end; a fixing member that fixes the optical fiber by surrounding an entire circumference of at least the distal end portion of the optical fiber; and an optical component that is installed at a position through which an extension line of the optical fiber at the distal end of the optical fiber passes.

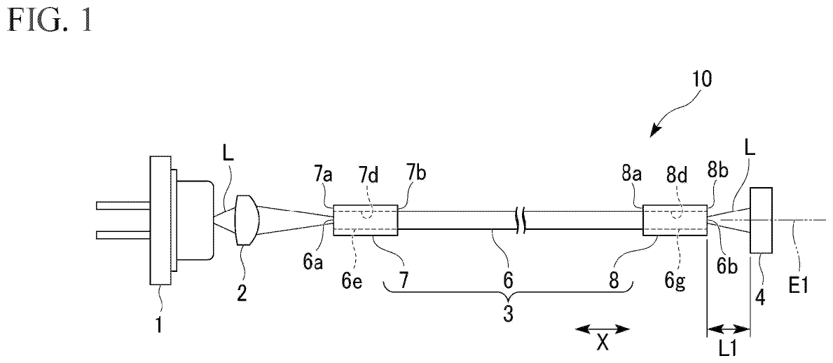

Hereinafter, one or more embodiments of the present invention will be described using FIGS. 1 to 3.

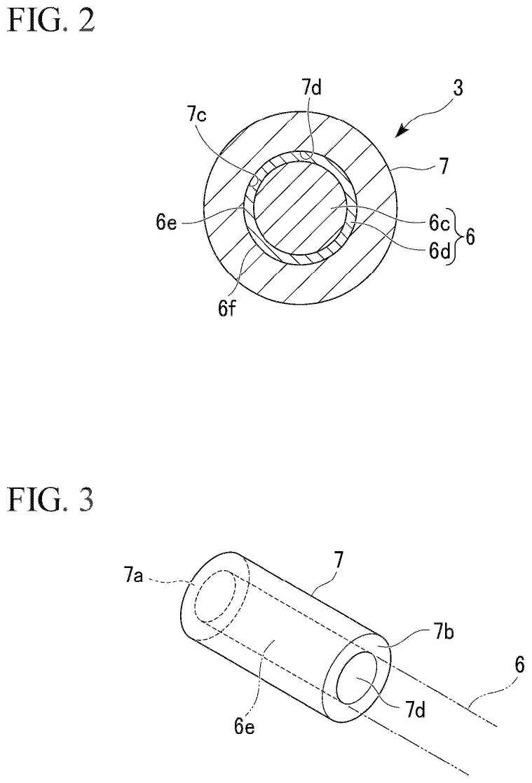

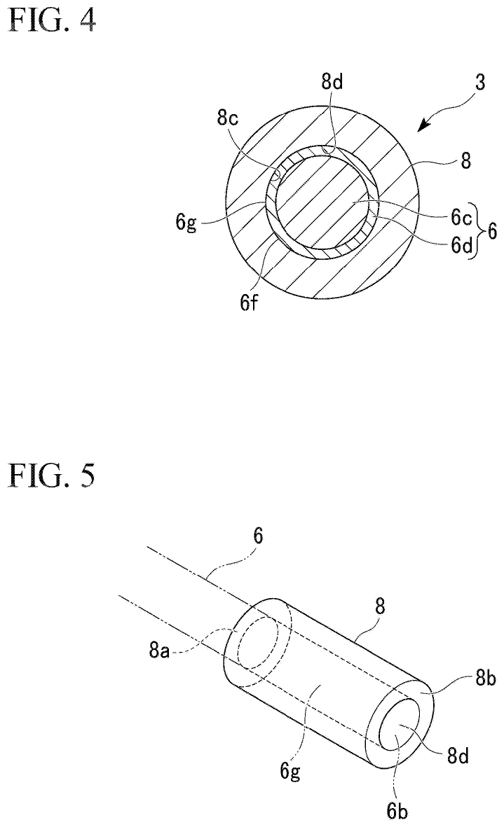

FIG. 1 is a schematic view of a light source device according to one or more embodiments of the present invention. FIG. 2 is a cross-sectional view of a proximal end portion of an optical fiber unit for a light source device in the light source device. FIG. 3 is a perspective view of a first fixing member of the optical fiber unit for a light source device. FIG. 4 is a cross-sectional view of a distal end portion of the optical fiber unit for a light source device in the light source device. FIGS. 2 and 4 show cross sections perpendicular to the longitudinal direction of the optical fiber. FIG. 5 is a perspective view of a second fixing member of the optical fiber unit for a light source device.

As shown in FIG. 1, a light source device 10 according to one or more embodiments includes a light source 1, a condensing lens 2, an optical fiber unit 3 for a light source device (hereinafter simply referred to as an optical fiber unit), and an optical component 4.

The light source 1 is, for example, a semiconductor laser (laser diode). For example, a blue semiconductor laser can be used as the light source 1. The central wavelength of the laser light launched from the light source 1 is, for example, 400 to 460 nm.

The optical fiber unit 3 includes an optical fiber 6, a first fixing member 7 (proximal end fixing member), and a second fixing member 8 (distal end fixing member).

As shown in FIG. 2, the optical fiber 6 is, for example, a multi-mode fiber. The optical fiber 6 has a core 6c and a cladding 6d surrounding the core 6c. The core 6c is made of, for example, pure silica glass substantially free of a dopant. The cladding 6d is made of, for example, fluorine-doped silica glass.

As shown in FIG. 1, laser light L from the light source 1 is incident on the proximal end 6a of the optical fiber 6. The proximal end 6a is also referred to as an incident end. The distal end 6b is an end opposite to the proximal end 6a, and is a launch end from which the laser light L is launched. The longitudinal direction of the optical fiber 6 may be referred to as “X direction”.

As shown in FIGS. 2 and 3, the first fixing member 7 is formed in a tubular shape (for example, a cylindrical shape). The longitudinal direction of the first fixing member 7 coincides with the longitudinal direction (X direction) of the optical fiber 6.

As shown in FIG. 1, a portion (proximal end portion 6e) including the proximal end 6a of the optical fiber 6 is inserted into the insertion hole 7d of the first fixing member 7. The proximal end portion 6e is a part of the optical fiber 6 in the longitudinal direction. The proximal end portion 6e is circular shape in the cross section which is orthogonal to the longitudinal direction (X direction) of the core 6c. The non-circularity of the core 6c in the cross section of the proximal end portion 6e is, for example, 1% or less. The non-circularity can be calculated, for example, based on the following Expression (1).

$$\begin{matrix}[ Expression 1 ] & \\ non \text{-} circularity [ \% ] = ( \frac{\begin{matrix}major diameter of core - \\ minor diameter of core\end{matrix}}{average diameter of core} ) \times 100 & ( 1 )\end{matrix}$$

As shown in FIG. 2, the first fixing member 7 surrounds the entire circumference of the proximal end portion 6e of the optical fiber 6. The inner peripheral surface 7c of the first fixing member 7 is bonded to the outer peripheral surface 6f (the outer peripheral surface of the cladding 6d) of the optical fiber 6 in direct contact with the entire circumference. Thereby, the first fixing member 7 fixes the proximal end portion 6e.

The inner peripheral surface 7c of the first fixing member 7 may be fused to the outer peripheral surface 6f. The first fixing member 7 may be fused to the entire circumference of the outer peripheral surface 6f of the proximal end portion 6e. The shape (outer shape) of the first fixing member 7 in the cross section orthogonal to the longitudinal direction (X direction) is circular.

As shown in FIG. 1, the proximal end 7a of the first fixing member 7 is disposed on a side closer to the proximal end 6a in the longitudinal direction (X direction) of the optical fiber 6. The end opposite to the proximal end 7a is referred to as a distal end 7b. The position of the proximal end 7a of the first fixing member 7 in the X direction coincides with the position of the proximal end 6a of the optical fiber 6 in the X direction.

The end surface of the proximal end 7a may be located on the same plane as the end surface (proximal end surface) of the proximal end 6a.

The core diameter (the outer diameter of the core 6c) of the optical fiber 6 at the proximal end 7a of the first fixing member 7 is referred to as a first proximal core diameter. The core diameter of the optical fiber 6 at the distal end 7b is referred to as a first distal core diameter. A difference (first core diameter difference) between the first proximal core diameter and the first distal core diameter may be 10% or less of the first proximal core diameter. Here, the core diameter is calculated based on the following Expression ( 2).

Core diameter(μm)=(major diameter of core (μm)+minor diameter of core(μm)/2 (2)

If the first core diameter difference is 10% or less of the first proximal core diameter, the difference between the numerical aperture (NA) at the proximal end 6a of the optical fiber 6 and the NA at the distal end 6b can be kept small. As shown in FIGS. 4 and 5, the second fixing member 8 is formed in a tubular shape (for example, a cylindrical shape). The longitudinal direction of the second fixing member 8 coincides with the longitudinal direction (X direction) of the optical fiber 6.

As shown in FIG. 1, a portion (distal end portion 6g) including the distal end 6b of the optical fiber 6 is inserted into the insertion hole 8d of the second fixing member 8. The distal end portion 6g is a part of the optical fiber 6 in the longitudinal direction. The core 6c in the distal end portion 6g is circular shape in the cross section orthogonal to the longitudinal direction (X direction). The non-circularity of the core 6 in the cross section of the distal end portion 6g is, for example, 1% or less.

As shown in FIG. 4, the second fixing member 8 surrounds the entire circumference of the distal end portion 6g of the optical fiber 6. The inner peripheral surface 8c of the second fixing member 8 is bonded to the outer peripheral surface 6f (the outer peripheral surface of the cladding 6d) of the optical fiber 6 in direct contact with the entire circumference. Thereby, the second fixing member 8 fixes the distal end portion 6g.

The inner peripheral surface 8c of the second fixing member 8 may be fused to the outer peripheral surface 6f. The second fixing member 8 may be fused to the entire circumference of the outer peripheral surface 6f of the distal end portion 6g. The shape (outer shape) of the second fixing member 8 in the cross section orthogonal to the longitudinal direction (X direction) is circular.

As shown in FIG. 1, the proximal end 8a of the second fixing member 8 is disposed on a side closer to the proximal end 6a in the longitudinal direction (X direction) of the optical fiber 6. The end opposite to the proximal end 8a is referred to as a distal end 8b. The position of the distal end 8b of the second fixing member 8 in the X direction coincides with the position of the distal end 6b of the optical fiber 6 in the X direction.

The end surface (distal end surface) of the distal end 8b may be located on the same plane as the end surface (distal end surface) of the distal end 6b.

The core diameter (the outer diameter of the core 6c) of the optical fiber 6 at the proximal end 8a of the second fixing member 8 is referred to as a second proximal core diameter. The core diameter of the optical fiber 6 at the distal end 8b is referred to as a second distal core diameter. A difference (second core diameter difference) between the second proximal core diameter and the second distal core diameter may be 10% or less of the second proximal core diameter.

If the second core diameter difference is 10% or less of the second proximal core diameter, the difference between the NA at the proximal end 6a of the optical fiber 6 and the NA at the distal end 6b can be kept small.

The constituent material of the first fixing member 7 and the second fixing member 8 may be a material whose viscosity when melted by heating is close to the viscosity when the constituent material of the optical fiber 6 is melted, it is because the first fixing member 7 and the second fixing member 8 are easily integrated with the optical fiber 6 respectively. When the linear expansion coefficient of the constituent material is close to the linear expansion coefficient of the constituent material of the optical fiber 6, breakage of the first fixing member 7 and the second fixing member 8 hardly occurs at the time of manufacture (during cooling). Examples of the constituent material include silica glass, multicomponent glass and the like. In particular, silica glass is excellent in durability under high temperature and high humidity environments and radiation environments.

The number of holes of the fixing member may be one for one optical fiber. For example, in the case of using seven optical fibers, the number of holes of the fixing member may be seven, and arranged concentrically and uniformly.

In other words, distal end portions of the plurality of optical fibers may be separated from each other by the fixing member. With this configuration, it is possible to limit non-circular deformation of the core of the optical fiber after the fusion of the optical fiber and the fixing member.

The optical fiber 6 is disposed at a position where the proximal end 6a faces the emission part of the light source 1 through the condensing lens 2.

The optical component 4 is provided to face the distal end 6b of the optical fiber 6. The optical component 4 is installed at a position through which the extension line E1 of the optical fiber 6 at the distal end 6b passes.

The optical component 4 is, for example, a phosphor. The phosphor is formed of, for example, a YAG-based crystal material. A part of the blue light emitted from the light source 1 to the optical component 4 through the optical fiber 6 is converted to fluorescence by the optical component 4. The converted fluorescence and unconverted light are combined into white light. The optical component 4 is, for example, in a plate shape, and is installed perpendicularly to the extension line E1.

The optical component 4 can be installed at a position away from the distal end 6b of the optical fiber 6 in the X direction. Thereby, a rise in temperature caused by the reflected light or the like from the optical component 4 can be limited, and the burnout of the distal end 6b can be prevented.

Here, the burnout is, for example, that the distal end of the optical fiber is damaged by absorbing the radiant heat and reflected light (fluorescent light and laser light) from the optical component and generating heat. For example, in an optical fiber unit in which an optical fiber is fixed with an adhesive such as epoxy, when the adhesive at the distal end of the optical fiber is burnt out, the adhesive evaporates and adheres to the end surface of the optical fiber. And then, the end surface of the optical fiber absorbs launched light stronger than the reflected light, so the power of the launched light may decrease, and damage to surrounding parts may occur.

The optical component 4 is not limited to a phosphor, and may be a lens, a large core optical fiber, a mirror, a scattering plate, a rod (for example, made of glass or resin), a panel, or the like.

The scattering plate has a function of scattering light. The scattering plate may have a rough surface structure for scattering light, a structure including light scattering particles, and the like.

The optical component 4 may be configured by combining two or more of a phosphor, a lens, a large core optical fiber, a mirror, a scattering plate, a rod, and a panel. For example, the optical component 4 may be a combination of a lens and a phosphor, or a combination of a scattering plate and a phosphor.

The distance L1 between the optical component 4 and the distal end 6b is, for example, 0 to 5 mm. The optical component 4 may be installed in contact with the distal end 6b (that is, the distance L1 is set to 0 mm). The connection between the optical component 4 and the distal end 6b may be fusion or mechanical fixation.

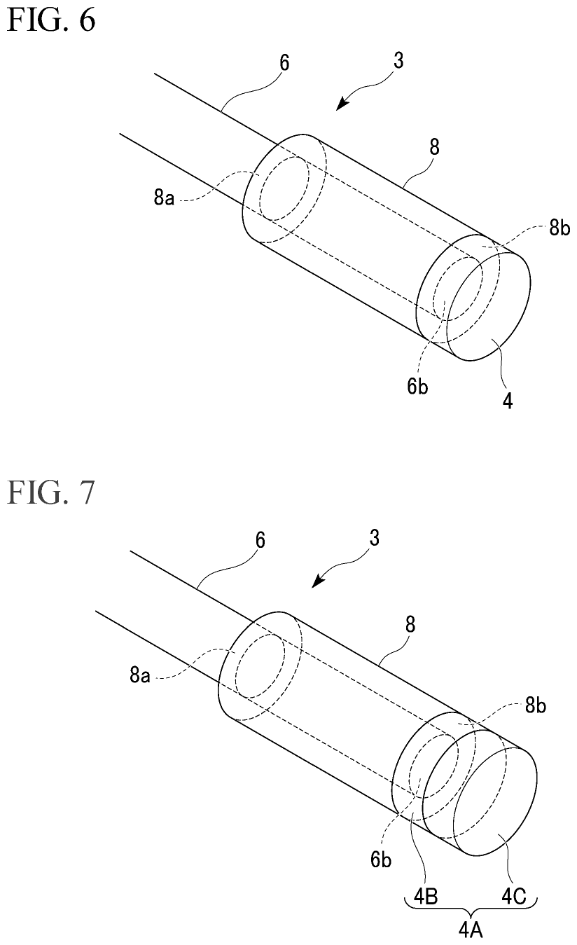

FIG. 6 is a schematic view of a first example of a structure in which the optical component 4 is fixed in contact with the end surface (distal end surface) of the distal end of the optical fiber unit 3. In order to fix the optical component 4 (phosphor) to the distal end of the optical fiber unit 3, methods of integrating the phosphor with the distal end of the optical fiber unit 3 may be to heat and melt the distal end of the optical fiber unit 3 and attach the powder material of the phosphor to the distal end of the optical fiber unit 3, or to mix the powder material of the phosphor and binder and attach to the distal end of the optical fiber unit 3. The binder may be an inorganic material or a silicone resin.

Raw materials of the phosphor include, for example, Ce: YAG, Ce: LuAG, and the like. Ce: YAG is a YAG-based crystal material containing Ce. Ce: LuAG is LuAG containing Ce.

The inorganic binder includes, for example, one or more of Al₂O₃, SiO₂, TiO₂, BaO, and Y₂O_{3.}

FIG. 7 is a schematic view of a second example of the structure in which the optical component 4A is fixed in contact with the end surface (distal end surface) of the distal end of the optical fiber unit 3. The optical component 4A has a structure in which the scattering plate 4B and the phosphor 4C are laminated. The scattering plate 4B is provided on the distal end surface of the optical fiber unit 3. The phosphor 4C is provided on the outer surface (the surface opposite to the optical fiber unit 3 side) of the scattering plate 4B.

Instead of the scattering plate, a rough surface structure may be formed on the distal end surface of the optical fiber unit 3, or scattering particles may be directly attached to the distal end surface of the optical fiber unit 3. If light can be scattered by the rough surface structure or the adhesion of scattering particles, uniform launched light can be obtained.

As shown in FIGS. 6 and 7, by adopting a structure in which the optical components 4, 4A are in contact with and attached to the distal end of the optical fiber unit 3, the distal end portion of the optical fiber unit 3 can be miniaturized.

The distal end of the optical fiber unit 3 is at least one of the distal end 6b and the distal end 8b. In a case where the positions of the distal end 6b and the distal end 8b in the X direction are different from each other, the distal end of the optical fiber unit 3 is a distal end which is positioned more forward (rightward in FIG. 1), out of the distal end 6b and the distal end 8b. In a case where the positions of the distal end 6b and the distal end 8b in the X direction are the same, the distal end of the optical fiber unit 3 is both the distal end 6b and the distal end 8b.

Next, an example of a method of manufacturing the light source device 10 will be described.

As shown in FIG. 1, a pair of tubular bodies (not shown) to be the first fixing member 7 and the second fixing member 8 (see FIGS. 3 and 5) are prepared. The tubular body is made of, for example, glass. The inner diameter of the tubular body is slightly larger than the outer diameters of the proximal end portion 6e and the distal end portion 6g of the optical fiber 6.

The proximal end portion 6e and the distal end portion 6g of the optical fiber 6 are respectively inserted into the pair of tubular bodies, and the tubular bodies are respectively bonded to the proximal end portion 6e and the distal end portion 6g all around the circumference. For example, the inner surfaces of the insertion holes of the tubular bodies are integrated with the proximal end portion 6e and the distal end portion 6g of the optical fiber 6 by heating and melting. Thus, the optical fiber unit 3 is obtained.

The optical fiber 6 is installed at a position where the proximal end 6a faces the emission part of the light source 1 through the condensing lens 2. The optical component 4 is provided at a position facing the distal end 6b of the optical fiber 6. Thereby, the light source device 10 shown in FIG. 1 is obtained.

In the light source device 10, the laser light L output from the light source 1 passes through the condensing lens 2 and is incident on the optical fiber 6 from the proximal end 6a. The laser light L is launched from the distal end 6b through the optical fiber 6 and is applied to the optical component 4. A part of the blue light applied to the optical component 4 is converted to fluorescence by the optical component 4. The converted fluorescence and unconverted light are combined and launched as white light.

In the light source device 10, the second fixing member 8 is provided at the distal end portion 6g of the optical fiber 6. The second fixing member 8 is fixed so as to surround the entire circumference of the distal end portion 6g of the optical fiber 6. Therefore, even when the output of the laser light L is high, the distal end of the optical fiber unit 3 is unlikely to be burnt out by heat or light. Therefore, the optical component 4 can be disposed at a position close to the distal end of the optical fiber unit 3.

In the light source device 10, since the distal end portion 6g of the optical fiber 6 is surrounded by the second fixing member 8, deformation of the distal end portion 6g hardly occurs at the time of manufacture, and the non-circularity of the cross section of the distal end portion 6g can be reduced. Therefore, disturbance of the beam profile is unlikely to occur.

Therefore, it is possible to provide the light source device 10 in which the distal end 6b of the optical fiber 6 is unlikely to be burnt out even when the output of the incident light is high, and disturbance of the beam profile is unlikely to occur.

Further, in the light source device 10, since the distal end portion 6g of the optical fiber 6 is surrounded by the second fixing member 8, the optical fiber 6 is less likely to be damaged at the time of cleaning or the like. Thus, the light source device 10 is excellent in handleability.

The second fixing member 8 is in contact with the distal end portion 6g so as to surround the entire circumference of the distal end portion 6g, so the distal end portion 6g can be firmly fixed without using a structure that is easily burnt out. Therefore, burnout at the distal end of the optical fiber unit 3 can be avoided, and the fixing strength to the distal end portion 6g can be increased.

The second fixing member 8 may be fused to the distal end portion 6g in order to prevent burnout and to improve fixing strength. In particular, the second fixing member 8 may be fused to the entire circumference of the distal end portion 6g in order to prevent burnout and to improve fixing strength.

In the light source device 10, the first fixing member 7 is provided at the proximal end portion 6e of the optical fiber 6.

Therefore, when the output of the light source 1 is high or when the light intensity is increased by light condensing by the condensing lens 2, the proximal end of the optical fiber unit 3 is unlikely to be burnt out.

In the optical fiber unit 3, the second fixing member 8 is fixed so as to surround the entire circumference of the distal end portion 6g of the optical fiber 6. Therefore, even when the output of the laser light L is high, the distal end of the optical fiber unit 3 is unlikely to be burnt out by heat or light. Therefore, the optical component 4 can be disposed at a position close to the distal end of the optical fiber unit 3.

In the optical fiber unit 3, since the distal end portion 6g of the optical fiber 6 is surrounded by the second fixing member 8, deformation of the distal end portion 6g hardly occurs at the time of manufacture, and the non-circularity of the cross section of the distal end portion 6g can be reduced. Therefore, disturbance of the beam profile is unlikely to occur.

Therefore, the distal end 6b of the optical fiber 6 is unlikely to be burnt out even when the output of the incident light is high, and disturbance of the beam profile is unlikely to occur.

In the optical fiber unit 3, since the distal end portion 6g of the optical fiber 6 is surrounded by the second fixing member 8, the optical fiber 6 is less likely to be damaged at the time of cleaning or the like. Therefore, the optical fiber unit 3 is excellent in handleability.

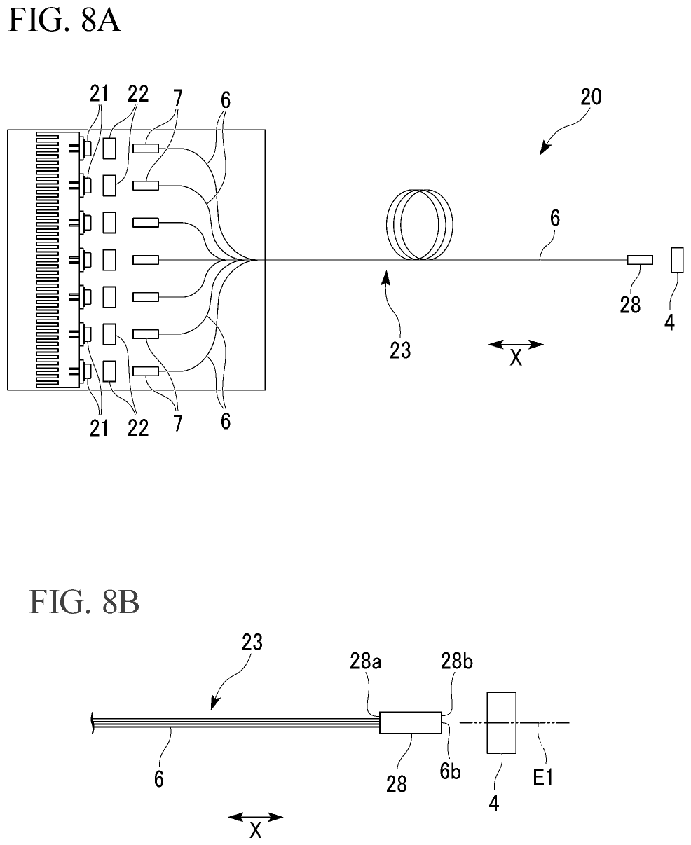

Hereinafter, one or more embodiments of the present invention will be described using FIGS. 8A to 10. In addition, a description may be omitted and the same reference numbers are used for parts in common with the above-described embodiments.

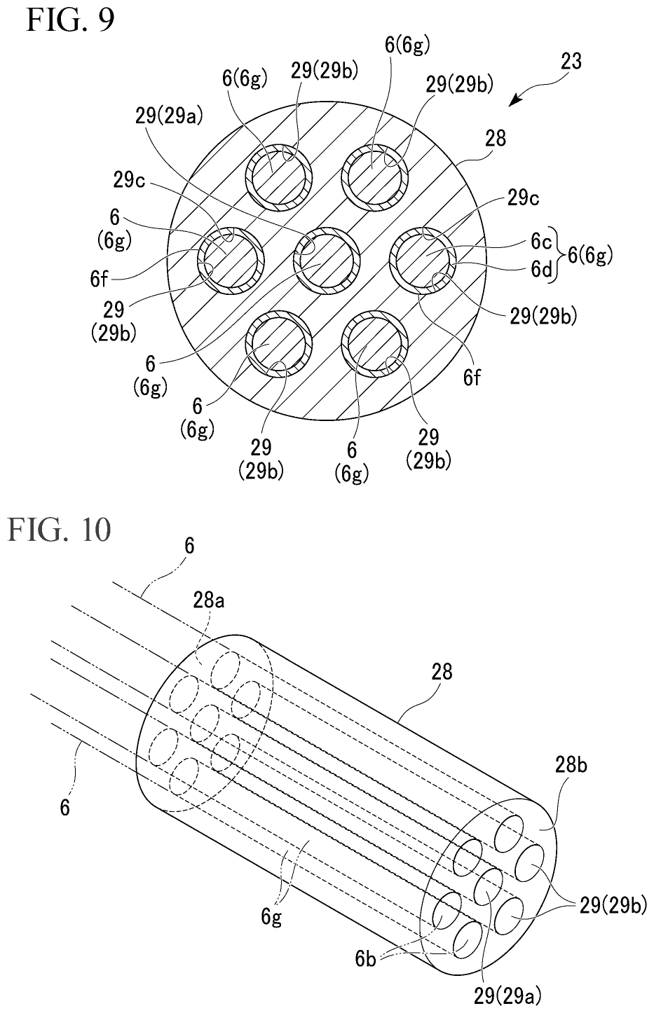

FIG. 8A is a schematic view of a light source device according one or more embodiments of to the present invention. FIG. 8B is a schematic view of a part of the light source device. FIG. 9 is a cross-sectional view of the distal end portion of the optical fiber unit of the light source device. FIG. 9 is a view showing a cross section perpendicular to the longitudinal direction of the optical fiber. FIG. 10 is a perspective view of the second fixing member.

As shown in FIGS. 8A and 8B, a light source device 20 according to one or more embodiments includes a plurality of light sources 21, a plurality of condensing lenses 22, an optical fiber unit 23, and an optical component 4.

The light source 21 can be the same as, for example, the light source 1 shown in FIG. 1.

The condensing lens 22 can be the same as, for example, the condensing lens 2 shown in FIG. 1.

The optical fiber unit 23 includes a plurality of optical fibers 6, a plurality of first fixing members 7, and a second fixing member 28 (distal end fixing member).

As shown in FIGS. 9 and 10, the second fixing member 28 is formed in a column shape (for example, a cylindrical shape) having a plurality of insertion holes 29.

As shown in FIG. 9, as the plurality of insertion holes 29, there are a central insertion hole 29a and a plurality of peripheral insertion holes 29b. The central insertion hole 29a is formed at the center of the second fixing member 28 in a cross section orthogonal to the longitudinal direction (X direction) of the optical fiber 6. A plurality of (six in one or more embodiments) peripheral insertion holes 29b are formed at equal intervals in the circumferential direction at the position on the outer peripheral side of the central insertion hole 29a. The peripheral insertion holes 29b are disposed along the circle surrounding the central insertion hole 29a. The central insertion hole 29a and the peripheral insertion holes 29b are arranged such that the lines connecting the respective centers are in the form of a triangular lattice. The center-to-center distance between adjacent insertion holes 29 is equal.

The insertion holes 29 (the central insertion hole 29a and the peripheral insertion hole 29b) are formed apart from each other in a cross section orthogonal to the X direction. Therefore, the distal end portions 6g of the optical fiber 6 are separated from each other by the second fixing member 28.

The constituent material of the second fixing member 28 may be a material whose viscosity when melted by heating is close to the viscosity when the constituent material of the optical fiber 6 is melted. This is because the second fixing member 28 is easily integrated with the optical fiber 6. When the linear expansion coefficient of the constituent material is close to the linear expansion coefficient of the constituent material of the optical fiber 6, breakage of the second fixing member 28 hardly occurs at the time of manufacture (during cooling). Examples of the constituent material include silica glass, multicomponent glass and the like. In particular, silica glass is excellent in durability under high temperature and high humidity environments and radiation environments. The longitudinal direction of the second fixing member 28 coincides with the longitudinal direction (X direction) of the optical fiber 6.

As shown in FIG. 10, distal end portions 6g of the optical fibers 6 are inserted through the plurality of insertion holes 29 of the second fixing member 28, respectively.

As shown in FIG. 9, the second fixing member 28 surrounds the entire circumference of the distal end portion 6g of each of the optical fibers 6. The inner peripheral surface 29c of the insertion hole 29 is bonded to the outer peripheral surface 6f of the optical fiber 6 in direct contact with the entire circumference. The second fixing member 28 is in contact with each of the distal end portions 6g of the plurality of optical fibers 6 so as to surround the entire circumference. Thereby, the second fixing member 28 fixes the distal end portions 6g of the plurality of optical fibers 6.

The inner peripheral surface 29c of the insertion hole 29 may be fused to the outer peripheral surface 6f. The second fixing member 28 may be fused to the entire circumference of the outer peripheral surface 6f of the distal end portion 6g.

As shown in FIG. 10, the proximal end 28a of the second fixing member 28 is disposed on a side closer to the proximal end 6a in the longitudinal direction (X direction) of the optical fiber 6. The end opposite to the proximal end 28a is referred to as a distal end 28b. The position of the distal end 28b of the second fixing member 28 in the X direction coincides with the position of the distal end 6b of the optical fiber 6 in the X direction. The end surface (distal end surface) of the distal end 28b may be located on the same plane as the distal end surface of the distal end 6b.

The core diameter (the outer diameter of the core 6c) of the optical fiber 6 at the proximal end 28a of the second fixing member 28 is referred to as a second proximal core diameter. The core diameter of the optical fiber 6 at the distal end 28b is referred to as a second distal core diameter. A difference (second core diameter difference) between the second proximal core diameter and the second distal core diameter may be 10% or less of the second proximal core diameter.

If the second core diameter difference is 10% or less of the second proximal core diameter, it is possible to limit the difference between the NA at the proximal end 6a of the optical fiber 6 and the NA at the distal end 6b.

Next, an example of a method of manufacturing the light source device 20 will be described.

A tubular body (not shown) to be the first fixing member 7 (see FIG. 3) and a fixing member (a base material) (not shown) to be the second fixing member 28 (see FIG. 10) are prepared. The fixing member (base material) is made of, for example, glass, and has an insertion hole. The inner diameter of the insertion hole is slightly larger than the outer diameter of the distal end portion 6g of the optical fiber 6.

The proximal end portion 6e of the optical fiber 6 is inserted into the tubular body, and the distal end portion 6g is inserted into the insertion hole of the fixing member (base material). The tubular body and the fixing member (base material) are respectively bonded to the proximal end portion 6e and the distal end portion 6g all around the circumference. For example, the inner surfaces of the insertion holes of the tubular bodies and the fixing members (base materials) are integrated with the proximal end portion 6e and the distal end portion 6g of the optical fiber 6 by heating and melting. Thus, the optical fiber unit 23 is obtained.

The optical fiber 6 is installed at a position where the proximal end 6a faces the emission part of the light source 1 through the condensing lens 2, and the optical component 4 is installed at a position facing the distal end 6b of the optical fiber 6.

Thereby, the light source device 20 shown in FIG. 8A is obtained.

In the light source device 20, the laser light L output from the light sources 1 passes through the condensing lenses 2 and is incident on the optical fibers 6 from the proximal ends 6a. The laser light L is launched from the distal end 6b of the optical fiber 6 and is applied to the optical component 4 to be launched as white light.

In the light source device 20, the second fixing member 28 is fixed so as to surround the entire circumference of the distal end portion 6g of the optical fiber 6. Therefore, even when the output of the laser light L is high, the distal end of the optical fiber unit 23 is unlikely to be burnt out by heat or light.

In the light source device 20, since the distal end portion 6g of the optical fiber 6 is surrounded by the second fixing member 28, deformation of the distal end portion 6g hardly occurs at the time of manufacture, and the non-circularity of the cross section of the distal end portion 6g can be reduced. Therefore, disturbance of the beam profile is unlikely to occur.

Therefore, it is possible to provide the light source device 20 in which the distal end 6b of the optical fiber 6 is unlikely to be burnt out even when the output of the incident light is high, and disturbance of the beam profile is unlikely to occur.

In the light source device 20, since the distal end portion 6g of the optical fiber 6 is surrounded by the second fixing member 28, the optical fiber 6 is less likely to be damaged at the time of cleaning or the like. Therefore, the light source device 20 is excellent in handleability.

The second fixing member 28 is in contact with the distal end portion 6g so as to surround the entire circumference of the distal end portion 6g, so the distal end portion 6g can be firmly fixed without using a structure that is easily burnt out. Therefore, burnout at the distal end of the optical fiber unit 3 can be avoided, and the fixing strength to the distal end portion 6g can be increased. The second fixing member 28 may be fused to the distal end portion 6g in order to prevent burnout and to improve fixing strength. In particular, the second fixing member 28 may be fused to the entire circumference of the distal end portion 6g in terms of burnout prevention and fixing strength improvement.

In the optical fiber unit 23, since the second fixing member 28 is fixed so as to surround the entire circumference of the distal end portion 6g of the optical fiber 6, even if the output of the laser light L is high, the distal end of the optical fiber unit 23 is unlikely to be burnt out by heat or light.

In the optical fiber unit 23, since the distal end portion 6g of the optical fiber 6 is surrounded by the second fixing member 28, deformation of the distal end portion 6g hardly occurs at the time of manufacture, and the non-circularity of the cross section of the distal end portion 6g can be reduced. Therefore, disturbance of the beam profile is unlikely to occur.

Therefore, the distal end 6b of the optical fiber 6 is unlikely to be burnt out even when the output of the incident light is high, and disturbance of the beam profile is unlikely to occur.

In the optical fiber unit 23, since the distal end portion 6g of the optical fiber 6 is surrounded by the second fixing member 28, the optical fiber 6 is less likely to be damaged at the time of cleaning or the like. Therefore, the optical fiber unit 23 is excellent in handleability.

In the light source device 20, using one of the plurality of optical fibers 6 as a detection port, the output adjustment and abnormality detection of the light source 21 may be performed while measuring the intensity of the reflected light from the optical component 4. Further, under high radiation, the detection port can be used as a port for detecting a radiation dose by being combined with a component such as a scintillator.

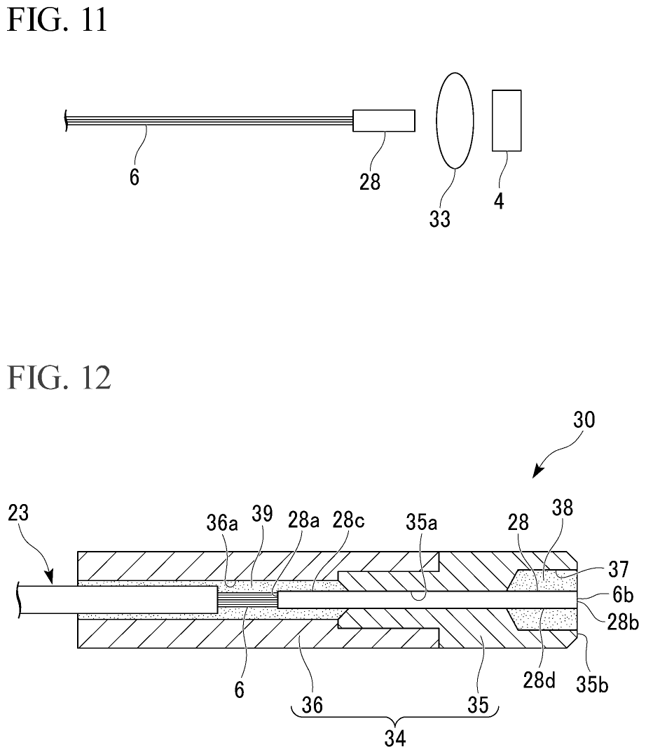

FIG. 11 is a schematic view of a part of a modification example of the light source device 20.

As shown in FIG. 11, a condensing lens 33 may be provided between the second fixing member 28 and the optical component 4. In this configuration, the laser light is launched from the distal end of the optical fiber 6, passes through the condensing lens 33, and is applied to the optical component 4 to be launched as white light.

One or more embodiments of the present invention will be described using FIG. 12. A description is omitted and the same reference numbers are used for parts in common with the above-described embodiments.

FIG. 12 is a schematic view of a part of a light source device according to one or more embodiments of the present invention.

As shown in FIG. 12, in the light source device 30, the optical fiber unit 23 is inserted into the holding member (holder) 34. The light source device 30 has the same configuration as the light source device 20 according to one or more embodiments described above except that the holding member 34 is provided.

The holding member 34 includes a front cylindrical portion 35 and a rear cylindrical portion 36 connected to a rear end of the front cylindrical portion 35.

The front cylindrical portion 35 is made of, for example, metal (stainless steel, aluminum or the like). The second fixing member 28 is inserted into the insertion hole 35a of the front cylindrical portion 35.

A front end recess 37 is formed on the front end surface 35b of the front cylindrical portion 35. At least a portion of the distal end portion 28d (portion including the distal end 28b) of the second fixing member 28 is exposed in the front end recess 37.

The rear cylindrical portion 36 is made of, for example, metal (stainless steel, aluminum or the like). The proximal end portion 28c(a portion including the proximal end 28a) of the second fixing member 28 is inserted through the insertion hole 36a of the rear cylindrical portion 36. The proximal end portion 28c is a portion on the proximal end side of the second fixing member 28 rather than the distal end portion 28d.

The distal end portion 28d of the second fixing member 28 is adhesively fixed to the front cylindrical portion 35 by the first adhesive 38 (inorganic adhesive or silicone adhesive) filled in the front end recess 37. The inorganic adhesive is, for example, a ceramic adhesive. Since inorganic adhesives and silicone adhesives are excellent in heat resistance, burnout is unlikely to occur.

In the second fixing member 28, if at least the distal end portion 28d is adhesively fixed to the front cylindrical portion 35 by the first adhesive 38, an effect to prevent burnout can be obtained.

The proximal end portion 28c of the second fixing member 28 is fixed to the rear cylindrical portion 36 by the second adhesive 39 (organic adhesive or silicone adhesive) filled in the insertion hole 36a of the rear cylindrical portion 36. Since the organic adhesive is excellent in adhesive strength, the second fixing member 28 can be firmly fixed to the rear cylindrical portion 36.

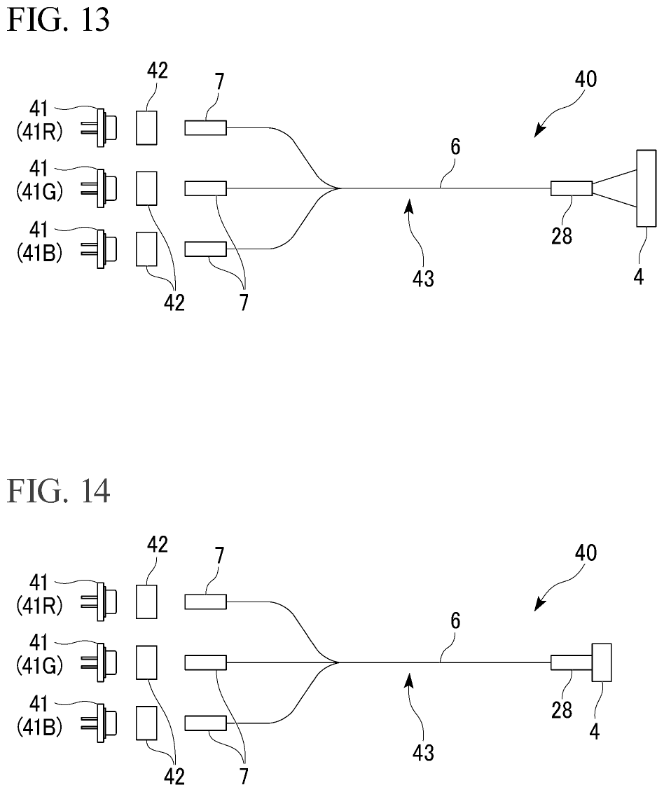

FIG. 13 is a schematic view of a part of a light source device according to one or more embodiments of the present invention. In addition, a description is omitted and the same reference numbers are used for parts in common with the above-described embodiments.

As shown in FIG. 13, a light source device 40 according to one or more embodiments includes a plurality of light sources 41, a plurality of condensing lenses 42, an optical fiber unit 43, and an optical component 4.

Two or more of the plurality of light sources 41 may launch light which have different wavelengths. For example, in the case where the plurality of light sources 41 includes a light source of red light (wavelength 630 to 650 nm), a light source of green light ( 520 to 550 nm), and a light source of blue light ( 440 to 460 nm), light of various colors can be emitted by adjusting the output of light of each wavelength. In this case, white light can be obtained without using a phosphor.

The light source 41 of the light source device 40 includes a light source 41R of red light, a light source 41G of green light, and a light source 41B of blue light.

The optical fiber unit 43 includes a plurality of optical fibers 6, a plurality of first fixing members 7, and a second fixing member 28.

The optical component 4 is, for example, a scattering plate. By using a scattering plate as the optical component 4, uniform light can be obtained.

As shown in FIG. 13, the optical component 4 may be installed at a position away from the distal end of the optical fiber unit 43 (at least one of the distal end of the optical fiber 6 and the distal end of the second fixing member 28).

As shown in FIG. 14, the optical component 4 may be at a position to abut the distal end of the optical fiber unit 43.

Rough surface structure may be formed on the distal end 6b (see FIG. 8B) of the optical fiber 6, or scattering particles may be directly attached to the distal end 6b (see FIG. 8B) of the optical fiber 6. If light can be scattered by the rough surface and scattering particles, uniform launched light can be obtained. As described above, in the case where rough surface or the like capable of scattering light are formed on the distal end surface of the optical fiber 6, uniform light can be obtained without the scattering plate.

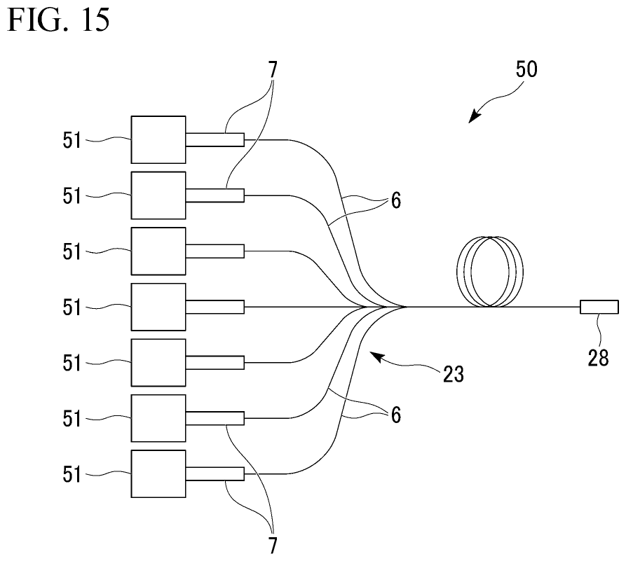

FIG. 15 is a schematic view of a light source device according to one or more embodiments of the present invention. In FIG. 15, illustration of the optical component is omitted. In addition, a description is omitted and the same reference numbers are used for parts in common with the above-described embodiments.

As shown in FIG. 15, a light source device 50 of one or more embodiments includes a plurality of light sources 51, an optical fiber unit 23, and an optical component (not shown).

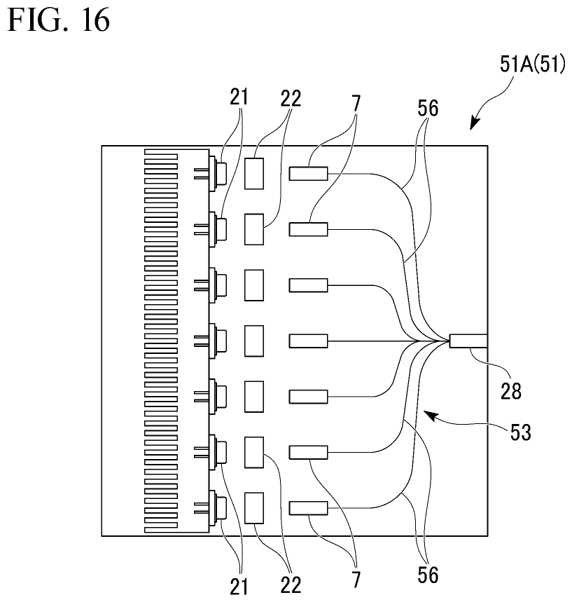

FIG. 16 is a schematic view showing a light source 51A which is an example of the light source 51. As shown in FIG. 16, the light source 51A is configured to include a plurality of light sources 21, a plurality of condensing lenses 22, and an optical fiber unit 53. The optical fiber unit 53 includes a plurality of optical fibers 56, a plurality of first fixing members 7, and a second fixing member 28. The optical fiber 56 has the same configuration as the optical fiber 6 shown in FIG. 1.

In the light source 51A, the laser light output from the light source 21 passes through the condensing lens 22 and the optical fiber 56, and is incident on the optical fiber 6 of the optical fiber unit 23 shown in FIG. 15.

In the light source device 50, the light source 51 ( 51A) includes the plurality of light sources 21, so the output of the launched light can be increased.

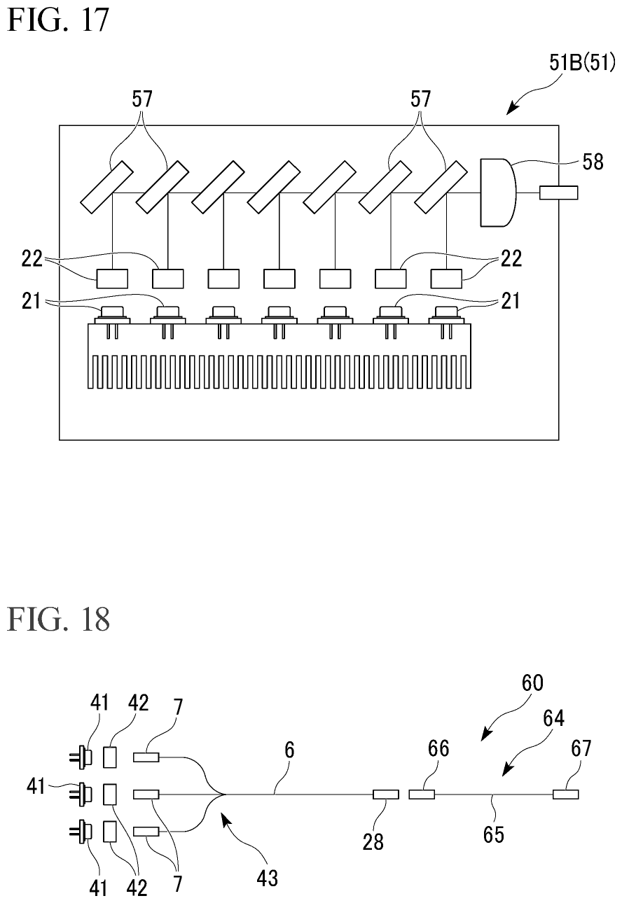

FIG. 17 is a schematic view showing a light source 51B which is another example of the light source 51. As shown in FIG. 17, the light source 51B is configured to include a plurality of light sources 21, a plurality of condensing lenses 22, a plurality of mirrors 57, and a condensing lens 58.

In the light source 51B, the laser light output from the light source 21 passes through the condensing lens 22, the mirror 57, and the condensing lens 58, and is incident of the optical fiber 6 of the optical fiber unit 23 shown in FIG. 15.

In the light source device 50, the light source 51 (51B) includes the plurality of light sources 21, so the output of the launched light can be increased.

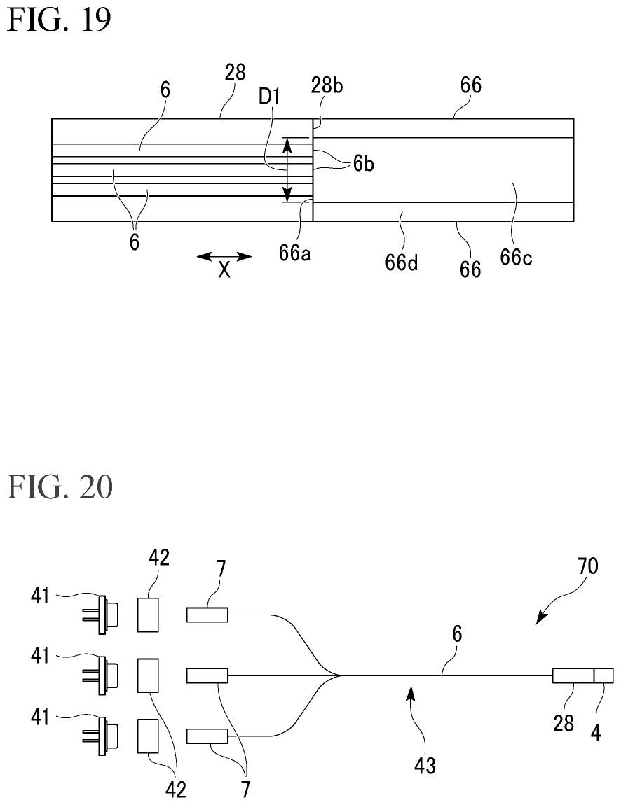

FIG. 18 is a schematic view of a light source device according to one or more embodiments of the present invention. FIG. 19 is a cross-sectional view showing a part of the light source device of FIG. 18. In addition, a description is omitted and the same reference numbers are used for parts in common with the above-described embodiments.

As shown in FIG. 18, a light source device 60 according to one or more embodiments includes a plurality of light sources 41, a plurality of condensing lenses 42, an optical fiber unit 43, and an optical component 64.

The optical component 64 includes a relay optical fiber 65, a first end optical fiber 66 connected to a first end (first end) of the relay optical fiber 65, and a second end optical fiber 67 connected to a second end (second end) of the relay optical fiber 65.

As shown in FIG. 19, a first end 66a of the first end optical fiber 66 is connected to the distal end 28b of the second fixing member 28. The first end optical fiber 66 is a large core optical fiber and has a core 66c and a cladding 66d surrounding the core 66c. The core 66c is made of, for example, pure silica glass, germanium-doped silica glass, or the like. The cladding 6d is made of, for example, pure silica glass. For connection between the first end optical fiber 66 and the second fixing member 28, fusion connection, connector connection or the like can be employed.

The outer diameter D1 of the core 66c at the first end 66a is set such that the core 66c collectively covers the distal ends 6b (distal end surfaces) of all the optical fibers 6 held by the second fixing member 28 when viewed from the X direction.

In other words, the outer shape of the core 66c at the first end 66a is set such that the distal ends 6b (distal end surfaces) of all the optical fibers 6 held by the second fixing member 28 are collectively disposed inside the core 66c when viewed from the X direction.

The first end optical fiber 66 may be an optical fiber of a type different from the optical fiber 6. For example, when the refractive index of the core 66c of the first end optical fiber 66 is higher than the refractive index of the core of the optical fiber 6, it is considered that reflection at the connection surface occurs and light returned to the core of the optical fiber 6 decreases. Therefore, the adverse effect on the light source 41 due to the return light can be avoided.

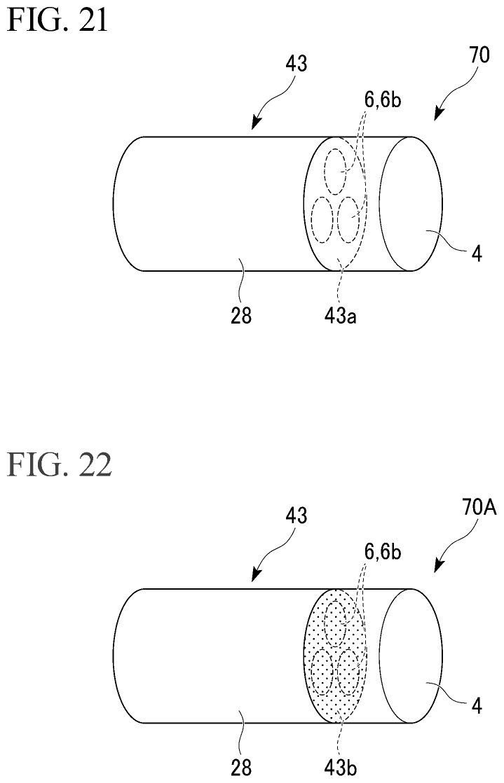

FIG. 20 is a schematic view of a first configuration example according to one or more embodiments of the present invention. FIG. 21 is a schematic view of the structure of the distal end portion of the optical fiber unit. In addition, a description is omitted and the same reference numbers are used for parts in common with the above-described embodiments.

As shown in FIG. 20, the light source device 70 includes a plurality of (for example, three) light sources 41, a plurality (for example, three) condensing lenses 42, an optical fiber unit 43, and an optical component 4. The optical fiber unit 43 includes a plurality (for example, three) of optical fibers 6, a plurality (for example, three) of first fixing members 7, and a second fixing member 28.

As shown in FIG. 21, the optical component 4 is a phosphor. The optical component 4 is fixed to the distal end surface 43a of the optical fiber unit 43 (the end surfaces of the second fixing member 28 and the optical fiber 6). The optical component 4 is fixed in contact with the distal end surface 43a without a gap without using a fixing tool. The optical component 4 is directly in contact with the distal end surface 43a and fixed to the distal end surface 43a. The optical component 4 may be fixed to at least the distal end surface (distal end 6b) of the optical fiber 6.

In order to fix the optical component 4 (phosphor) to the distal end surface 43a of the optical fiber unit 43, for example, fusion and adhesion can be employed.

In the case of fusion, in a state where the distal end surface 43a of the optical fiber unit 43 is heated and melted, the fluorescent material is attached to the distal end surface 43a to fix the phosphor to the distal end surface 43a.

The fluorescent material may be a mixture of a powder material (raw material) of a phosphor and a binder (for example, an inorganic binder, a silicone resin, or the like), or may be only a powder material of a phosphor.

Raw materials of the phosphor include, for example, Ce: YAG, Ce: LuAG, and the like. Ce: YAG is a YAG-based crystal material containing Ce. Ce: LuAG is LuAG containing Ce.

The inorganic binder includes, for example, one or more of Al₂O₃, SiO₂, TiO₂, BaO, and Y₂O₃.

When fusion is employed as a method of fixing the optical component 4 to the distal end surface 43a, the connection loss is small, and the transmission light rate is high. When fusion is employed, no adhesive is used, so high output laser light can be handled.

In the case of adhesion, a mixture of the powder material of the phosphor and an adhesive (epoxy resin, silicone resin, or the like) is attached to the distal end surface 43a and cured to fix the phosphor to the distal end surface 43a.

Since the optical component 4 (phosphor) is fixed to the optical fiber unit 43 without using a fixing tool, the light source device 70 can be miniaturized as compared with the case of using the fixing tool. Since the optical component 4 (phosphor) is disposed on the distal end surface 43a of the optical fiber unit 43 without a gap, the reflection of the laser light in the optical component 4 can be limited.

The distal end surface 43a may have a light scattering structure (a rough surface structure for scattering light, a structure including light scattering particles, or the like). The specific configuration example is shown below.

FIG. 22 is a schematic view of the structure of the distal end portion of the optical fiber unit of the second configuration example according to one or more embodiments.

In the optical fiber unit of the second configuration example according to one or more embodiments, at least the distal end surface of the optical fiber has a light scattering structure, the optical component is a phosphor formed of a fluorescent material, and the phosphor is fixed so as to abut at least the distal end surface of the optical fiber.

The optical device 70A shown in FIG. 22 in the second configuration example according to one or more embodiments differs from the optical device 70 shown in FIG. 21. Instead of the distal end surface 43a in the first configuration example according to one or more embodiments, the distal end surface 43b having a light scattering structure (a rough surface structure for scattering light, a structure including light scattering particles, or the like) is used.

The phosphor 4 is fixed to the distal end surface 43b by the above-described fusion, adhesion, or the like.

In addition, as in the case of FIG. 21, also in FIG. 22, the optical component 4 is fixed in contact with the distal end surface 43b without a gap without using a fixing tool. The optical component 4 (phosphor) is provided on the distal end surface 43b of the optical fiber unit 43.

Since the distal end surface 43b has a light scattering structure (a rough surface structure for scattering light, a structure including light scattering particles, or the like), in the light source device 70A, the light is scattered by the light scattering structure and the density of light becomes uniform, and uniformed launched light is obtained.

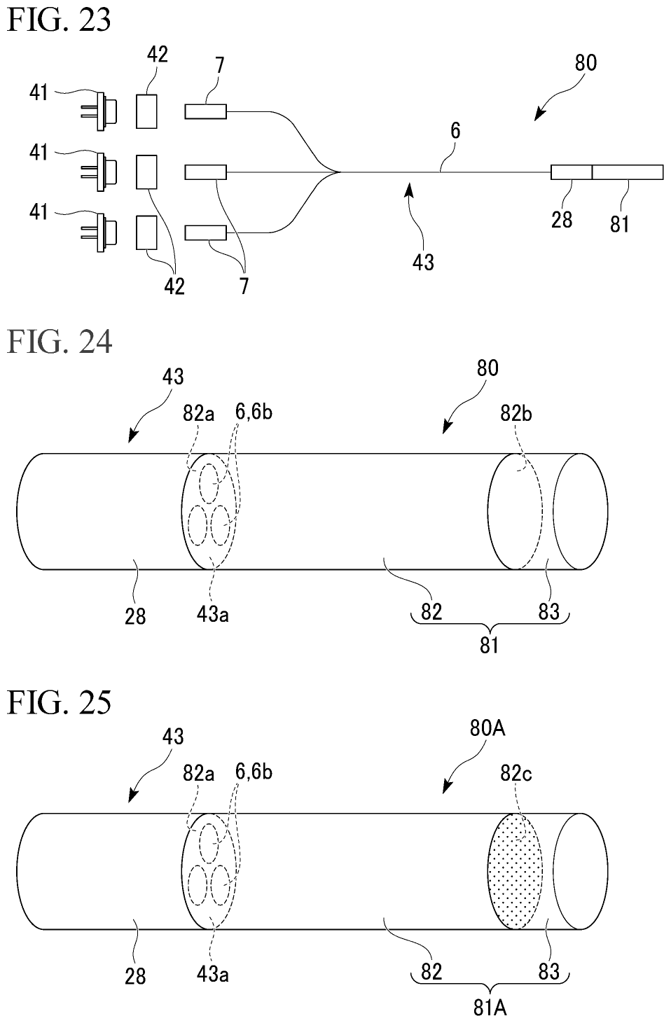

FIG. 23 is a schematic view of a first configuration example according to one or more embodiments of the present invention. FIG. 24 is a schematic view of the structure of the distal end portion of the optical fiber unit. In addition, a description is omitted and the same reference numbers are used for parts in common with the above-described embodiments.

As shown in FIG. 23, the light source device 80 includes a plurality of (for example, three) light sources 41, a plurality (for example, three) condensing lenses 42, an optical fiber unit 43, and an optical component 81.

As shown in FIG. 24, in the light source device 80, the optical component 81 is fixed to the distal end surface 43a of the optical fiber unit 43. The optical component 81 is fixed in contact with the distal end surface 43a without a gap without using a fixing tool. The optical component 81 includes a relay fiber 82 and a phosphor 83. A first end surface 82a (first end surface) of the relay fiber 82 is fixed to the distal end surface 43a of the optical fiber unit 43. The phosphor 83 is fixed to a second end surface 82b (second end surface) of the relay fiber 82.

The relay fiber 82 is a large core optical fiber having a core (relay core) and a cladding (relay cladding) surrounding the core.

In other words, the optical component has a phosphor formed of a fluorescent material, and a relay fiber having a relay core and a relay cladding surrounding the relay core, and having a first end surface and a second end surface, the first end surface of the relay fiber may be fixed so as to abut at least the distal end surface of the optical fiber, and the phosphor is fixed to the second end surface of the relay fiber.

The outer diameter of the core (relay core) at the end surface 82a of the relay fiber 82 is defined such that the core (relay core) of the relay fiber 82 collectively covers the distal ends 6b (a plurality of distal end surfaces) of all the optical fibers 6 (a plurality of optical fibers) held by the second fixing member 28, as viewed from the longitudinal direction of the optical fiber 6 (similarly, viewed from the longitudinal direction of the relay fiber 82) (see FIG. 19).

In other words, the optical component 8 has a relay fiber having a relay core and a relay cladding surrounding the relay core, and the outer shape of the relay core is set such that the distal end surfaces (a plurality of distal end surfaces) of all of the plurality of optical fibers 6 held by the second fixing member 28 are collectively disposed inside the relay core, as viewed from the longitudinal direction of the relay fiber 82.

The relay fiber 82 is, for example, a single core fiber in which the relay core satisfies the above-described outer diameter condition.

As the large core optical fiber as the relay fiber 82, the relay core may satisfy the above-described outer diameter condition. For example, fibers with a large core diameter among optical fibers for ordinary communication applications may be used, and fibers with a larger core diameter than the optical fibers for ordinary communication applications may be used. For example, as a large core optical fiber, a fiber with a core diameter of 50 to 2000 μm and a cladding diameter of 80 to 2200 μm may be used.

Further, in order to allow the light from the optical fiber 6 to be efficiently incident and propagate, the numerical aperture (NA) of the relay fiber 82 is configured to be a value equal to or larger than the numerical aperture (NA) of the optical fiber 6.

Further, even if the numerical aperture (NA) of the relay fiber 82 is too higher than the numerical aperture (NA) of the optical fiber 6, the light launched from the optical fiber 6 to the relay fiber 82 spreads.

Therefore, the numerical aperture (NA) of the relay fiber 82 and the numerical aperture (NA) of the optical fiber 6 may be substantially equal (the numerical aperture (NA) of the relay fiber 82 is slightly higher), and the numerical aperture (NA) of the relay fiber 82 and the numerical aperture (NA) of the optical fiber 6 may be the same.

The relay fiber 82 is fixed to the distal end surface 43a by the above-described fusion, adhesion, or the like. The phosphor 83 is fixed to the end surface 82b of the relay fiber 82 by the above-described fusion, adhesion, or the like. When fusion is employed, the connection loss is small, and the light transmission rate is high. Further, since no adhesive is used, high output laser light can be handled. The connector connection may be employed to connect the optical fiber unit 43 and the relay fiber 82.

In the light source device 80, since the optical component 81 has the relay fiber 82, the light incident on the optical component 81 from the optical fiber 6 is uniformed in a process of propagating in the core (relay core) of the relay fiber 82. Therefore, the density of light becomes uniform, and uniformed launched light can be obtained. In a case where the plurality of light sources 41 have light sources launching light of different colors, the light from each optical fiber 6 is made uniform in the process of propagating through the relay fiber 82, so launched light with less color unevenness and speckles is obtained.

FIG. 25 is a schematic view of the structure of the distal end portion of the optical fiber unit of the second configuration example according to one or more embodiments.

As shown in FIG. 25, in the light source device 80A, the optical component 81A is fixed to the distal end surface 43a of the optical fiber unit 43.

That is, the phosphor 83 is fixed to the second end surface 82c (second end surface) of the relay fiber 82.

The phosphor 83 is fixed to the end surface 82c of the relay fiber 82 by the above-described fusion, adhesion, or the like.

The optical component 81A differs from the optical component 81 shown in FIG. 24 in that the end surface (second end surface) 82c having a light scattering structure (a rough surface structure for scattering light, a structure including light scattering particles, or the like) is used, instead of the end surface 82b in the first configuration example according to one or more embodiments.

Since the end surface 82c has a light scattering structure (a rough surface structure for scattering light, a structure including light scattering particles, or the like), in the light source device 80A, the light can be scattered by the relay fiber 82 and the end surface 82b having the light scattering structure, the density of the light becomes uniform, and a uniformed launched light can be obtained.

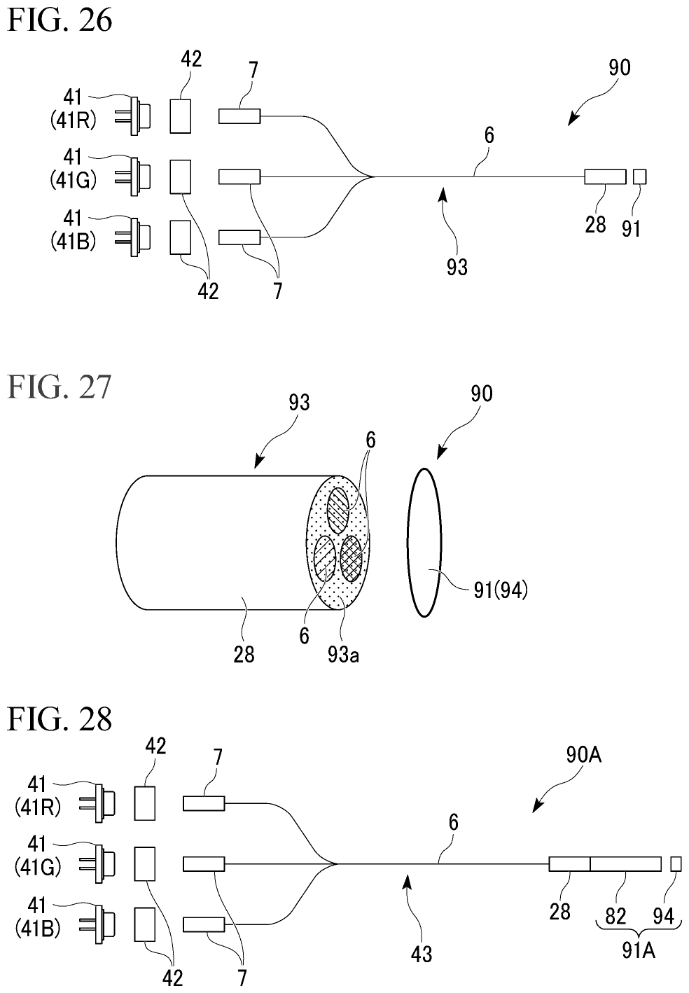

FIG. 26 is a schematic view of a first configuration example of a light source device according to one or more embodiments of the present invention. FIG. 27 is a schematic view of the structure of the distal end portion of the optical fiber unit 93. In addition, a description is omitted and the same reference numbers are used for parts in common with the above-described embodiments.

As shown in FIG. 26, a light source device 90 includes a plurality of (for example, three) light sources 41, a plurality (for example, three) condensing lenses 42, an optical fiber unit 93, and an optical component 91. The three light sources 41 are a light source 41R of red light (a red light source), a light source 41G of green light (a green light source), and a light source 41B of blue light (blue light source).

As shown in FIG. 27, the optical component 91 is a lens 94.

The distal end surface 93a of the optical fiber unit 93 (the distal end surfaces of the second fixing member 28 and the optical fiber 6) has a light scattering structure (a rough surface structure for scattering light, a structure including light scattering particles, or the like). The light launched from the three light sources 41 through the optical fiber 6 has colors different from each other (see FIG. 26), but is uniformed by being scattered by rough surface and scattering particles at the distal end surface 93a. Therefore, launched light with less color unevenness can be obtained.

Since the light source device 90 includes the light source 41R of red light, the light source 41G of green light, and the light source 41B of blue light, white light can be obtained without using a phosphor. In the light source device 90, the structure is simplified since no phosphor is required, and miniaturization can be achieved.

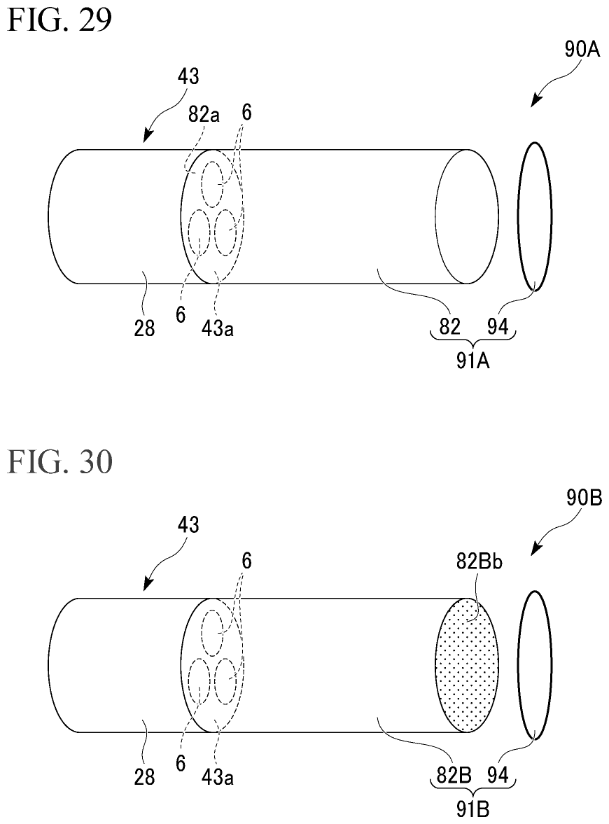

FIG. 28 is a schematic view of a second configuration example according to one or more embodiments. FIG. 29 is a schematic view of the structure of the distal end portion of the optical fiber unit 43.

As shown in FIG. 29, in the light source device 90A, an optical component 91A is provided on the distal end surface 43a of the optical fiber unit 43. The optical component 91A includes a relay fiber 82 (large core optical fiber) and a lens 94. A first end surface 82a (first end surface) of the relay fiber 82 is fixed to the distal end surface 43a of the optical fiber unit 43. The relay fiber 82 is fixed in contact with the distal end surface 43a without a gap without using a fixing tool.

The relay fiber 82 is fixed to the distal end surface 43a by the above-described fusion, adhesion, or the like. When fusion is employed, the connection loss is small, and the light transmission rate is high. Further, since no adhesive is used, high output laser light can be handled. The connector connection may be employed to connect the optical fiber unit 43 and the relay fiber 82.

Since the light source device 90A includes the light source 41R of red light, the light source 41G of green light, and the light source 41B of blue light, white light can be obtained without using a phosphor.

In the light source device 90A, since the optical component 91A has the relay fiber 82, the light incident on the optical component 81 from the optical fiber 6 is uniformed in a process of propagating in the core (relay core) of the relay fiber 82. Therefore, launched light with less color unevenness and speckles can be obtained.

FIG. 30 is a schematic view of the structure of the distal end portion of the optical fiber unit of the third configuration example according to one or more embodiments.

As shown in FIG. 30, in the light source device 90B, an optical component 91B is provided on the distal end surface 43a of the optical fiber unit 43. The optical component 91B differs from the optical component 91A shown in FIG. 29 in that the end surface 82Bb of the relay fiber 82B has a light scattering structure (a rough surface structure for scattering light, a structure including light scattering particles, or the like).

The other structures and configurations of the relay fiber 82B are the same as those of the relay fiber 82 in the first configuration example according to one or more embodiments described above, and thus a description thereof will be omitted.

In the light source device 90B, since the optical component 91B has the relay fiber 82B (large core optical fiber), the light incident on the optical component 91B from the optical fiber 6 is uniformed in a process of propagating in the core (relay core) of the relay fiber 82B. The light launched from the relay fiber 82B is further uniformed at the end surface 82Bb by being scattered by rough surface and scattering particles. Therefore, launched light with less color unevenness and speckles can be obtained.

It should be noted that the technical scope of the present invention is not limited to the above-described embodiments, and various modifications can be made without departing from the spirit of the present invention.

For example, as shown in FIGS. 1 and 8A, in the light source devices 10, 20 according to one or more embodiments, the first fixing member 7 is provided at the proximal end portion of the optical fiber 6. The light source device according to the embodiments described above may include the first fixing member in view of prevention of burnout or the like at the proximal end of the optical fiber unit, but a configuration without the first fixing member is also possible.

In the light source device 20 shown in FIGS. 8A and 8B, the optical component 4 (phosphor) is installed perpendicularly to the extension line E1 of the optical fiber 6 at the distal end 6b, but as shown in FIG. 31, the optical component 4 may be installed obliquely with respect to the line E1. The inclination angle a with respect to the extension line E1 is, for example, more than 0° and less than 90°.

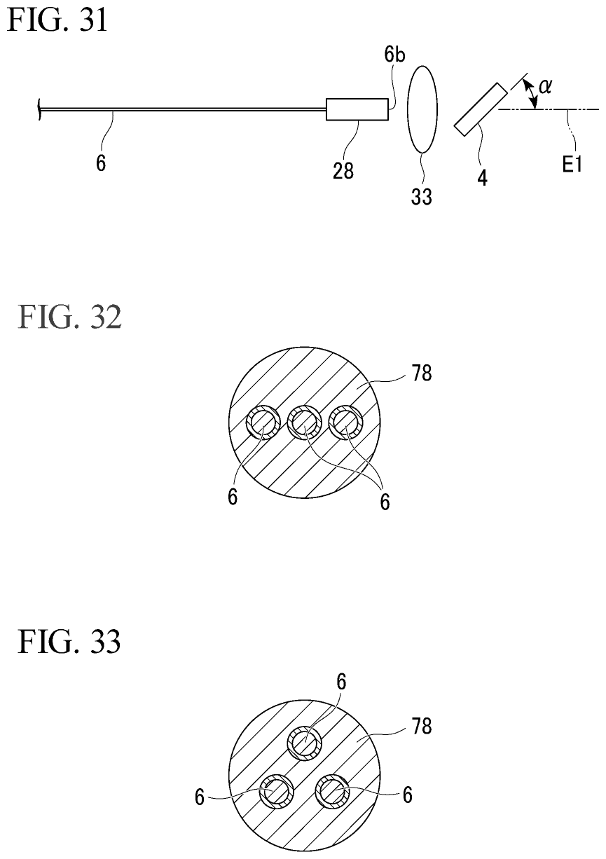

The structure of the optical fiber unit is not limited to the structure shown in FIG. 9. FIGS. 32 to 36 are cross-sectional views of first to fifth modification examples of the optical fiber unit according to one or more embodiments described above. FIGS. 32 to 36 are views showing cross sections perpendicular to the longitudinal direction of the optical fiber.

The optical fiber unit of a first modification example shown in FIG. 32 has a plurality of optical fibers 6 and a second fixing member 78. The optical fibers 6 are arranged in a straight line in a row. The cross-sectional shape of the second fixing member 78 is circular.

In the optical fiber unit of a second modification example shown in FIG. 33, the plurality of optical fibers 6 are arranged in the form of a triangular lattice.

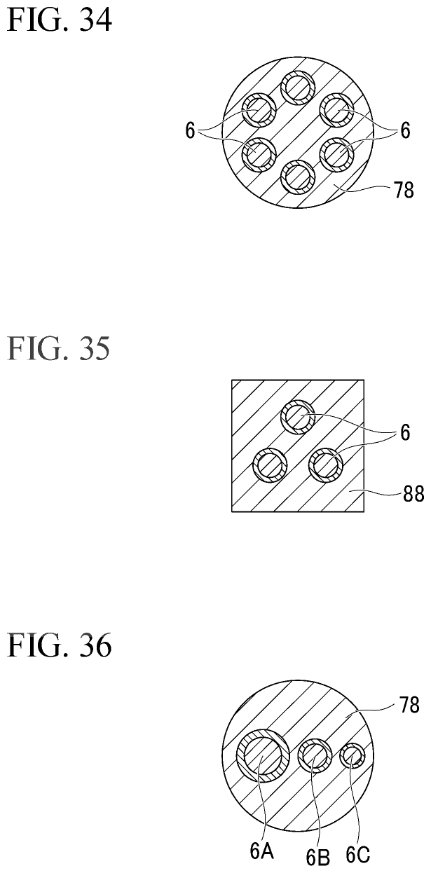

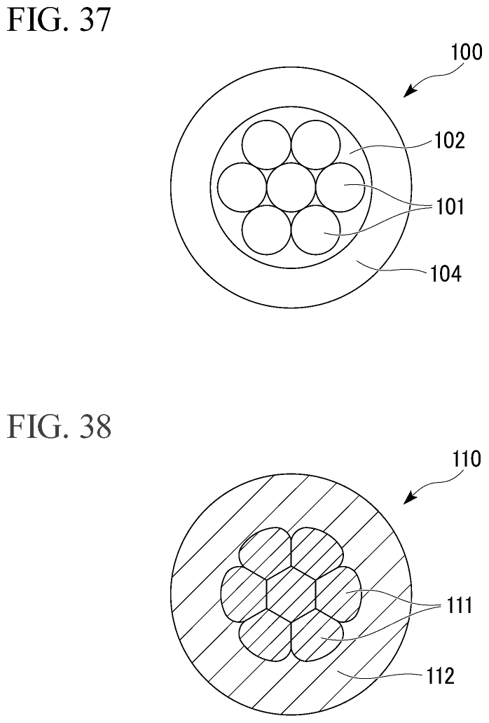

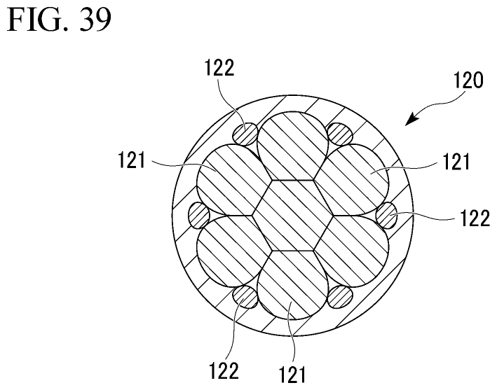

In the optical fiber unit of a third modification example shown in FIG. 34, the plurality of optical fibers 6 are at positions of six-fold rotational symmetry about the central axis of the second fixing member 78.

The optical fiber unit of the fourth modification example shown in FIG. 35 is different from the second modification example (see FIG. 33) in that the cross-sectional shape of a second fixing member 88 is rectangular. In addition, the cross-sectional shape of a fixing member is not specifically limited, and may be a polygonal shape, an elliptical shape, or the like.

In the optical fiber unit of a fifth modification example shown in FIG. 36, a plurality of optical fibers 6A to 6C have different outer diameters. The optical fiber 6 according to the above embodiments may be one or more than one.

### REFERENCE SIGNS LIST

1, 41, 41B, 41G, 41R light source

3, 23, 43, 93 optical fiber unit (optical fiber unit for light source device)

4, 4A, 64, 81, 81A, 91, 91A, 91B optical component

4C phosphor

6 optical fiber

6a proximal end

6b distal end

6g distal end portion

7 first fixing member

8, 28, 78, 88 second fixing member

10, 20, 30, 40, 50, 60, 70, 70A, 80, 80A, 90, 90A, 90B light source device

28b distal end

34 holding member

66c core

66d cladding

82, 82B relay fiber

E1 extension line

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A light source device comprising:
a light source that outputs laser light;
an optical fiber that comprises:
a proximal end on which the laser light is incident; and
a distal end portion comprising a distal end and a distal end surface at the distal end;
a fixing member that fixes the optical fiber by surrounding an entire circumference of the distal end portion; and
an optical component disposed at a position through which an extension line of the optical fiber at the distal end of the optical fiber passes.

2. The light source device according to claim 1, wherein the fixing member contacts the entire circumference of the distal end portion and surrounds the optical fiber.

3. The light source device according to claim 1, wherein the fixing member is fused to the distal end portion.

4. The light source device according to claim 1, wherein the fixing member is fused to the entire circumference of the distal end portion.

5. The light source device according to claim 1, wherein a difference between a core diameter of the optical fiber at a proximal end of the fixing member and a core diameter of the optical fiber at a distal end of the fixing member is 10% or less of the core diameter of the optical fiber at the proximal end of the fixing member.

6. The light source device according to claim 1, wherein the optical component abuts the distal end surface.

7. The light source device according to claim 6, wherein
the distal end surface has a light scattering structure, and
the optical component is a phosphor comprising a fluorescent material.

8. The light source device according to claim 6, wherein
the optical component comprises:
a phosphor comprising a fluorescent material; and
a relay fiber comprising:
a relay core;
a relay cladding surrounding the relay core;
a first end surface; and
a second end surface,
the first end surface abuts the distal end surface, and
the phosphor is fixed to the second end surface.

9. The light source device according to claim 8, wherein the second end surface has a light scattering structure.

10. The light source device according to claim 1, further comprising:
a plurality of light sources; and
a plurality of optical fibers, each comprising a distal end portion that comprises a distal end and a distal end surface at the distal end, wherein
the fixing member fixes the plurality of optical fibers by surrounding the distal end portions of the plurality of optical fibers.

11. The light source device according to claim 10, wherein
the distal end surfaces of the plurality of optical fibers have a light scattering structure,
the optical component is a phosphor comprising a fluorescent material, and
the phosphor abuts the distal end surfaces of the plurality of optical fibers.

12. The light source device according to claim 10, wherein the optical component comprises:
a phosphor formed of a fluorescent material, and
a relay fiber comprising:
a relay core;
a relay cladding surrounding the relay core;
a first end surface; and
a second end surface,
the first end surface abuts the distal end surfaces of the plurality of optical fibers,
the phosphor is fixed to the second end surface, and
when viewed from a longitudinal direction of the relay fiber, an outer shape of the relay core causes the distal end surfaces of all of the plurality of optical fibers to be collectively disposed inside the relay core.

13. The light source device according to claim 12, wherein the second end surface has a light scattering structure.

14. The light source device according to claim 10, wherein the plurality of light sources comprises:
a red light source;
a green light source; and
a blue light source.

15. The light source device according to claim 14, wherein the distal end surfaces of the plurality of optical fibers have a light scattering structure.

16. The light source device according to claim 14, wherein the optical component comprises a relay fiber comprising:
a relay core;
a relay cladding surrounding the relay core;
a first end surface; and
a second end surface,
the first end surface abuts the distal end surfaces, and
when viewed from a longitudinal direction of the relay fiber, an outer shape of the relay core causes the distal end surfaces of all of the plurality of optical fibers to be collectively disposed inside the relay core.

17. The light source device according to claim 16, wherein the second end surface has a light scattering structure.

18. The light source device according to claim 10, wherein the fixing member separates the distal end portions of the plurality of optical fibers from one another.

19. The light source device according to claim 1, wherein
the fixing member is inserted into a holder, and
the distal end portion is fixed to the holder using an inorganic adhesive or a silicone adhesive.

20. The light source device according to claim 10, wherein the fixing member contacts an entire circumference of each of the distal end portions.

21. The light source device according to claim 20, wherein the fixing member is fused to the distal end portions.

22. The light source device according to claim 21, wherein the fixing member is fused to the entire circumference of the distal end portions.
